(19) United States
(12) Patent Application Publication
(10) Pub. No.: US 2018/0174258 A1
(43) Pub. Date: Jun. 21, 2018

(54) METHOD AND SYSTEM FOR PROVIDING INFORMATION REGARDING THE LEGALITY OF PRODUCTS TO USERS IN REAL TIME

(71) Applicant: ICSS Enterprise, London (GB)

(72) Inventor: Iain LINDSAY, Addlestone (GB)

(73) Assignee: ICSS Enterprise

(21) Appl. No.: 15/381,694

(22) Filed: Dec. 16, 2016

(51) Int. Cl. G06Q 50/26; G06K 7/14; G06Q 50/18

(52) U.S. Cl. CPC G06Q 50/265; G06Q 50/18; G06K 7/1413

(57) ABSTRACT

A method includes receiving, from a user, indications of a product and a geographical region. The method further includes determining, in real time, a legality status of the product. The legality status indicates whether the product is legal in the geographical region. The method further includes displaying the legality status of the product. The method also includes storing the product, the geographical region, and the legality status of the product to a passport for the user.

### TECHNICAL FIELD

The disclosure relates generally to providing information regarding the legality of products to users in real time, and more specifically to providing information regarding the legality of performance-enhancing products to users in real time.

### BACKGROUND

A key threat to the integrity and future of all sports is doping. Doping is the administration of drugs to an athlete in order to inhibit or enhance sporting performance. As detection methods advance, we are witnessing more and more failed drug tests at every level of sport. Doping is now so endemic that we have reached the level where entire nations face blanket bans from premier sporting events. Trustworthy role models are now becoming increasingly rare as more and more world-renowned sporting icons that once inspired participation and championed clean and honest competition are reframed as drugs cheats. Integrity is at an all-time low. This is occurring in all sports, in all countries and at all levels of competition. As a result, doping has far reaching consequences for the future of sport and its respective global markets with implications that extend far beyond the fields of sporting competition and impact upon sponsors, athletes, fans and governments alike.

The World Anti-Doping Code, which World Anti-Doping Agency (WADA) is responsible for, has been adopted by more than 600 sports organizations, including international sports federations and national anti-doping organizations. WADA is a foundation initiated by the International Olympic Committee to promote, coordinate and monitor the fight against drugs in sports. The current anti-doping system, under the guidance of WADA, costs at least $170 million per year, mostly spent on covering the cost of performing approximately 270,000 doping tests annually. However, as WADA freely admits, drug testing has not proven to be particularly effective in either detecting or deterring cheats. More needs to be done to deliver cleaner sport for all.

To further compound matters, athletes also need to regulate their consumption of sports supplements and nutritional aids to ensure compliance with WADA testing. However, currently no anti-doping agency provides product-specific knowledge regarding nutritional supplements. Estimates for supplement industry revenues are generally positioned in excess of $30 billion, although one investment firm estimates that the entire nutrition industry revenue for 2009 was $108.3 billion. Despite its significance, the supplement industry is highly unregulated and a supplement manufacturer needs only provide a “reasonable expectation of safety” to enable them to go to market. In relation to safety and effectiveness, the burden of proof is ultimately transferred to the athlete to prove a supplement is unsafe or remove it from sale. Athletes must be empowered to make better decisions based on informed choices, enabling them to remain in compliance when it comes to avoiding banned substances. The trusted athlete application empowers athletes to make these better decisions.

### SUMMARY

According to one embodiment of the disclosure, a method includes receiving, from a user, indications of a product and a geographical region. The method further includes determining, in real time, a legality status of the product. The legality status indicates whether the product is legal in the geographical region. The method further includes displaying the legality status of the product. The method also includes storing the product, the geographical region, and the legality status of the product to a passport for the user.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a system for providing information regarding the legality of products to users in real time in accordance with a non-limiting embodiment of the present disclosure.

FIG. 2 illustrates a real-world implementation of a system for providing information regarding the legality of products to users in real time in accordance with a non-limiting embodiment of the present disclosure.

FIG. 3 illustrates a real-world implementation of a system for providing information regarding the legality of products to users in real time in accordance with a non-limiting embodiment of the present disclosure.

FIG. 4 illustrates a flow chart of a method for providing information regarding the legality of products to users in real time in accordance with a non-limiting embodiment of the present disclosure.

FIG. 5 illustrates a flow chart of a method for providing information regarding the legality of products to users in real time in accordance with a non-limiting embodiment of the present disclosure.

FIG. 6 illustrates a flow chart of a method for providing information regarding the legality of products to users in real time in accordance with a non-limiting embodiment of the present disclosure.

FIG. 7 illustrates a real-world implementation of a system for providing information regarding the legality of products to users in real time in accordance with a non-limiting embodiment of the present disclosure.

FIG. 8 illustrates a real-world implementation of a system for providing information regarding the legality of products to users in real time in accordance with a non-limiting embodiment of the present disclosure.

FIG. 9 illustrates a real-world implementation of a system for providing information regarding the legality of products to users in real time in accordance with a non-limiting embodiment of the present disclosure.

FIG. 10 illustrates a real-world implementation of a system for providing information regarding the legality of products to users in real time in accordance with a non-limiting embodiment of the present disclosure.

### DETAILED DESCRIPTION

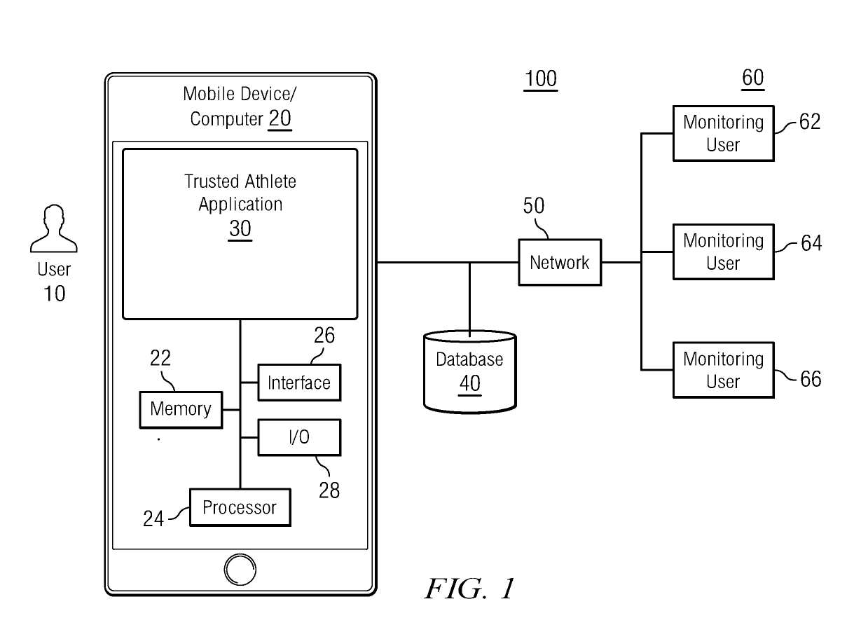

With reference to FIG. 1, a system 100 for providing information regarding the legality of products to users in real time is illustrated in accordance with a non-limiting embodiment of the present disclosure. System 100 includes a computer 20. Computer 20 may be a mobile device or tablet. Computer 20 may be a desktop or laptop computer. System 100 also includes a memory 22, processor 24, interface 26, and input/output (I/O) 28. Processor 13 loads instructions from memory 22 and executes them. Memory 22 may include temporary or permanent storage or memory, for example random access memory (RAM), a hard disk drive (HDD), a solid state drive (SDD), network attached storage (NAS), a USB thumb drive or flash drive, an optical drive such as a compact disc (CD) or digital video disc (DVD), cloud storage, or any other type of storage. System 100 may also comprise a trusted athlete application 30. Trusted athlete application 30 may run on computer 20, which may be a mobile device. Trusted athlete application 30 may utilize one or more of memory 22, processor 24, interface 26, and I/O 28. User 10 may use trusted athlete application 30 on computer 20. User 10 may be any user, including as an example an professional athlete or an amateur athlete. System 100 may also include database 40. Trusted athlete application 30 may store data to and retrieve data from database 40. System 100 may also include network 50 and one or more monitoring users 60, including as an example monitoring user 62, monitoring user 64, and monitoring user 66. Monitoring users 60 may include, for example, a parent, a coach, or a sponsor. Trusted athlete application 30 may send data or alerts over network 50 to monitoring users 60. Network 50 may include a wired or wireless local area network (LAN) or wide area network (WAN), the Internet, or the cellular network.

Trusted athlete application 30 may create a profile for user 10. The profile may include identifying information of user 10, including a photograph or illustration of user 10, a birthdate of user 10, the geographical location where user 10 is based, user 10's blood type, one or more sports associated with user 10, and the current and historical medical statuses of user 10, including for example fit for competition, unfit for competition, or suspended from competition. The profile may include one or more monitoring users 60 for user 10. User 10 may define monitoring users 60 through trusted athlete application 30.

Trusted athlete application 30 may create a passport for user 10. The passport may include one or more current or historical products that the user has used, currently uses, or intends to use in the future. Products may include, for example, drugs, including performance-enhancing drugs, medicines, supplements, and herbs. For example, products may include steroids, proteins, medicines, herbal remedies, and hormones, including human growth hormones. Trusted athlete application 30 may receive an indication of a first product from user 10. For example, user 10 may type a product name into trusted athlete application 30. As another example, user 10 may scan a barcode of a product using trusted athlete application 30. A mobile device or tablet, for example, may have a built-in camera. User 10 may use the built-in camera to take a picture of a barcode. As another example, user 10 may type a Universal Product Code (UPC) from a barcode into trusted athlete application 30. A barcode may uniquely identify a product. Trusted athlete application 30 may also receive an indication of one or more geographical regions from user 10. The one or more geographical regions may be the location where user 10 is based, or geographical locations to which user 10 may travel. For example, user 10 may be based in the United States, and may indicate that he or she would like to know whether a particular drug is legal in the United States. As another example, user 10 may be based in the United States but want to travel to another country or countries for a competition, for example the Olympics in Rio De Janeiro in Brazil. User 10 may then indicate “Brazil” in trusted athlete application 30.

Trusted athlete application 30 may determine, in real time, a legality status of the first product. The legality status may indicate, for example, whether the first product is legal in the first geographical region. For example, user 10 may wish to know whether ibuprofen is legal for athletes to take in the United States. User 10 may therefore scan the barcode for a bottle of ibuprofen and indicate “United States” in trusted athlete application 30. Trusted athlete application 30 may determine in real time whether ibuprofen is legal for athletes to take in the United States. Trusted athlete application 30 may then display whether the drug is legal in the requested geographical user. Trusted athlete application 30 may display that the drug is legal using, for example, a green icon, a check mark, and/or words indicating that the drug is legal. Trusted athlete application 30 may display that the drug is not legal using, for example, a red icon, a slashed circle, an “X,” and/or words indicating the drug is not legal. Trusted athlete application 30 may display that the drug is in a gray area of legality, for example because the drug can be taken but only under certain circumstances. Trusted athlete application 30 may display a yellow or orange icon and/or words indicating that the drug may or may not be legal.

Trusted athlete application 30 may also store the first product, the first geographical region, and the legality status of the first product to the passport for user 10. For example, trusted athlete application 30 may store ibuprofen, United States, and information indicating that ibuprofen is legal in the United States to user 10's passport. Trusted athlete application 30 may store any number of products, any number of geographical regions, and any number of legality statuses to user 10's passport. For example, user 10 may check the legality of ten different products in the both the United States and Canada if user 10 has upcoming events in both countries. Each product and geographical region may be displayed to user 10 in his or her passport.

Trusted athlete application 30 may use many means for determining the legality status of a particular product in a particular geographical region. Trusted athlete application 30 may retrieve a legality status associated with the product from memory 22 or retrieve a legality status associated with the product from database 40. Trusted athlete application 30 may retrieve legislation, laws, regulation, treatises, or other legal works that describe whether certain products are legal for an athlete to take in a geographical region. For example, trusted athlete application 30 may retrieve legislation from a country describing what medicines an athlete is not allowed to take in that country. Trusted athlete application 30 may then cross-check the legislation with the product that user 10 indicated an intent to use in that country, for example the product that user 10 scanned the barcode of Trusted athlete application 30 determines whether that medicine is legal in that country, and may repeat for as many geographical regions that user 10 indicated. A geographical region may be a country, a state, a city, a county, a group of any of the above, or any other geographical region. For example, user 10 may indicate that it wants to know whether a particular drug is legal in the European Union, or in the Gulf Cooperation Council (GCC). Or, as another example, user 10 may indicate that it wants to know whether a particular drug is legal in San Francisco, Calif.

Trusted athlete application 30 may collate medication and/or supplement data in real time (including searches, current and historical) of user 10. Trusted athlete application 30 may cross-check this data against prohibited lists and send automated reports at user input times (or instantly on demand) to a variety of stakeholders (including sponsors, coaches, parents, etc.). For example, trusted athlete application 30 may cross-check this data with WADA's “Prohibited List,” which is a list of substances and methods prohibited in-competition, out-of-competition, and in particular sports. It is updated annually. Substances and methods are classified by categories such as steriods, stimulants, or gene-doping. The Prohibited List may state whether a substance is permitted for medical or religious purposes, or whether an athlete must obtain a Therapeutic Use Exemption (TUE) to be permitted to use the substance. Trusted athlete application 30 may obtain this information and display it to user 10. Trusted athlete application 30 may request a TUE from the appropriate agency for a particular product or method. A TUE may be proactive or retroactive. Trusted athlete application 30 may cross-check current and/or historical Prohibited Lists. Trusted athlete application 30 may collate medication and/or supplement data in real time (including searches, current and historical) of user 10. Trusted athlete application 30 may cross-check these against prohibited lists such as WADA's Prohibited List and send real-time warnings to designated stakeholders if an unsafe supplement or medication is scanned (to a variety of users including parents, sponsors, coaches, etc.). For example, if user 10 scans or searches a banned product, trusted athlete application 30 may notify one or more monitoring users 60 that the user is at risk, potentially immediately.

Trusted athlete application 30 may warn user 10 of a potential or current anti-doping violation, including failure of a doping test, use of a banned substance or method, filing failures or missed tests, possessing a banned substance or method, trafficking a banned substance or method, administering a banned substance or method, complicity, or prohibited association.

Trusted athlete application 30 may, if a product that the user scanned cannot be found, return an error message to user 10. Trusted athlete application 30 may also prompt user 10 to add the product to database 40. Trusted athlete application 30 may receive, from user 10, a request to add a product to database 40. In response to receiving the request to add the product to database 40, trusted athlete application 30 may add the product into database 40. Trusted athlete application 30 may determine the legality status of the product, associate the legality status with the product in database 40, and store the legality status of the product to database 40. Trusted athlete application 30 may determine whether the legality status of a product has changed. In response to determining that the legality status of the product changed, trusted athlete application 30 may change the legality status of the product in database 40 and update the legality status stored to user 10's passport. The new legality status of the product may be displayed to user 10. An alert may be sent to user 10 notifying user 10 that the legality status of the product has changed. For example, if user 10 indicates that he or she is currently taking ibuprofen, and trusted athlete application 30 displays a green arrow legality status for ibuprofen, and ibuprofen is subsequently outlawed in the United States, trusted athlete application 30 may send user 10 an alert indicating that ibuprofen is no longer legal in the United States. Accordingly, user 10 will be aware of the legality change. This may help decrease the occurrences of accidental doping by athletes who are simply unaware of legislative changes. The alert may suggest that user 10 discontinue using the product.

Trusted athlete application 30 may alert user 10 a certain period of time prior to the dates that user 10 indicated he or she would travel so that user 10 has sufficient time to find out whether a product is legal in a certain geographical region, and if it is not, user 10 has a chance to stop taking the product and get any remnants of the product out of his or her system before the date of travel.

Trusted athlete application 30 may streamline the customs documentation process. For example, trusted athlete application 30 may, after user 10 inputs a particular drug and geographical region to which he or she wishes to travel, retrieve the customs paperwork associated with that geographical region for user 10 to complete. Trusted athlete application 30 may retrieve the customs paperwork from database 40, a separate database or server, or from, for example, the geographical region's website. Trusted athlete application 30 may pre-fill a portion or all of the customs paperwork out for user 10. For example, trusted athlete application 30 may fill out information identifying user 10 that is already stored in the application, the name of the product, information associated with the product, and information specific to the geographical region where the customs paperwork is being sent. As an example, trusted athlete application 30 may retrieve customs paperwork from Brazil in anticipation of user 10 traveling to the Olympics to compete, and pre-fill the paperwork with the medicines that user 10 current takes and intends to take in Brazil. Trusted athlete application 30 may facilitate automated interaction with relevant authorities, including by receiving one or more request from user 10 to communicate with one or more authority, and sending a communication to one or more relevant authority, for example by providing a form for user 10 to complete, then sending the contents of the form to relevant authorities, including for example customs departments of relevant countries or other geographical region. This may significantly reduce the amount of time and effort it takes user 10 to clear the medicines for travel. Trusted athlete application 30 may cross-check a product against a prohibited list and return and display pre-travel guidance to user 10 regarding that product, including for example information relating to whether the product is permitted in the geographical region, can be brought through customs, is disallowed for religious reasons, whether the product requires special handling or procedures upon arrival, etc.

Trusted athlete application 30 may receive a request from user 10 to report doping to an agency or geographical region governing body. For example, trusted athlete application 30 may receive a request from user 10 and submit the request to the applicable agency or governing body. Trusted athlete application 30 may receive the request through a button or other input available on the user interface of trusted athlete application 30. The reporting mechanism may include means of making the request anonymous or include user 10's contact information. Trusted athlete application 30 may request special whistleblower protection for user 10. Trusted athlete application 30 may allow user 10 to specify a geographical region and retrieve and display available whistleblower protections and applicable laws to user 10 for that geographical region. The request for reporting doping may include one or more recipients, a reason or reasons for reporting, one or more substances if known, and/or a statement by user 10.

One of more monitoring users 60 may be registered with trusted athlete application 30 to monitor user 10's usage of products to ensure that user 10 will pass all doping tests and will be found fit for competition. For example, a sponsor such as an athletics company may require user 10 to register a member of their company as a monitoring user 60. Thereafter, trusted athlete application 30 may send updates and alerts to the athletic company when user 10 scans a barcode, informing the company what drug user 10 added to his or her passport and what legality status the product has. For example, a major athletic company may require a track athlete to register them as a monitoring user before it agrees to sponsor the athlete. When the athlete has a cold and scans the cold medicine barcode to add the cold medicine to his or her passport, the major athletic company receives an alert from trusted athlete application 30 informing the company that the athlete added the cold medicine, and that the cold medicine is legal (or not legal) in the country where a competition is taking place in a month. The sponsor can then communicate with the athlete about its opinion as to whether the athlete should be taking that medicine or not. Accordingly, transparency and communication in the industry is heightened, and accidental doping is less likely to occur. The alert may be sent to any monitoring user in real time or as part of a report that is sent to the monitoring user. The report may be sent to the monitoring user at a predetermined time or at predetermined intervals, for example monthly or yearly. The report may be sent whenever a new product is scanned or added to user 10's passport. The report may be sent when user 10 requests that it be sent. User 10 may specify to which monitoring user (or any combination or monitoring users) the report is sent.

Trusted athlete application 30 may receive an indication of one or more products, and, for each product, one or more dates of use of the product and one or more geographical regions in which the product is used. For example, user 10 may indicate that it plans on using five different products, in two different countries, over the course of the next year in various competitions. The dates may be historical, current, or future. Trusted athlete application 30 may determine in real time the legality status of each product during the specified dates and in the specified geographical regions. Trusted athlete application 30 may then generate a report listing one or more of the product name, the legality status of that product, the dates of use, and the geographical regions of use. Trusted athlete application 30 may send the report to one or more monitoring users 60. User 10 may indicate an intent to use a product, may indicate that it uses the product currently, or may indicate that it used a product historically.

Trusted athlete application 30 may generate a biometric portion of user 10's profile. The biometric profile may include biometrics for user 10, including for example user 10's height, weight, heart rate, blood pressure, and other biometrics that may be of interest to an athlete. Trusted athlete application 30 may receive an indication of a health marker for user 10, for example his or her height or weight. Trusted athlete application 30 may determine whether the health marker is associated with a particular product. For example, trusted athlete application 30 may correlate the health marker with the product and determine whether the health marker may be associated with use of the product. For example, if user 10's weight decreases significantly, and user 10 has registered a weight loss supplement, trusted athlete application 30 may determine that user 10's weight loss is associated with use of the supplement. In this manner, trusted athlete application 30 may be able to determine side effects of particular products. For example, if many users of trusted athlete application 30 all experience significant blood pressure increases after taking a particular steroid, trusted athlete application 30 may determine that the steroid is correlated with the difference in blood pressure and alert authorities and/or user 10 of this correlation. User 10 thus may be better informed as to potentially harmful or dangerous products, including supplements. Trusted athlete application 30 may display an indication of whether the health marker is associated with the product. For example, trusted athlete application 30 may display a warning that the steroid is associated with potential blood pressure spikes on computer or mobile device 20. Trusted athlete application 30 may compile user 10's biometric profile inclusive of key health markers including heart rate, weight, body composition, food intolerances, among others. Trusted athlete application 30 may correlate these key health markers against key user input and/or technologically measured variables to determine causality of impact. Trusted athlete application 30 may measure diet, exercise type, duration and intensity, sleep, supplementation and medications and correlate these against user driven key performance indicators (KPIs) to map efficacy. For example, a 100m runner's KPI may be the runner's 100m run time. Trusted athlete application 30 may track trends among these key health markers and/or KPIs, and may identify the precise cause of the improvement if either the KPIs improve.

Trusted athlete application 30 may facilitate user 10 requesting a seal of approval for a product, for example a supplement. For example, trusted athlete application 30 may receive a request from user 10, may process the request, and may send the request to an appropriate authority (for example, WADA) to give a seal of approval to the supplement if the supplement passes certain tests. Trusted athlete application 30 may store and display one or more supplements to user 10, along with, for example, for each supplement, the company that makes the supplement, its geographical region of origin, and/or the chemical name for the supplement. One supplement may be displayed at a time, or multiple. Trusted athlete application 30 may store and display whether the supplement has received a seal of approval from an agency or governing body marking the supplement safe for human consumption. Trusted athlete application 30 may, for example, display a check mark or green logo to indicate approved or a slashed circle or red logo to indicate not approved. Any logo normally indicating approved or not approved may be used. Trusted athlete application 30 may also display text indicating approval or disapproval such as “approved by” the agency or governing body” or “not approved by” the agency or governing body. Trusted athlete application 30 may also store and display directions for how to administer the supplement safely, including what amount of the supplement is approved for use. Trusted athlete application 30 may also store and display one or more intended purposes for taking the supplement, for example muscle recovery or muscle growth. Trusted athlete application 30 may also store and display a description of the supplement, for example “What Is It?” Trusted athlete application 30 may also store and display whether the supplement has been batch tested. Trusted athlete application 30 may also store and display the sport-specific research status of the supplement to date. Trusted athlete application 30 may store and display the grade given to the supplement by the agency or governing body that gave the supplement the seal of approval, for example “A,” along with a key for determining what each grade means. For example, “A” may mean “strong scientific evidence for use,” “B” may mean “good scientific evidence for use,” “C” may mean “unclear scientific evidence for use,” “D” may mean “fair scientific evidence against use,” and “X” may mean “strong scientific evidence against use.” Trusted athlete application 30 may store and display the WADA status for the supplement, along with a description of that status. Trusted athlete application 30 may display a button that allows user 10 to press and store the supplement to user 10's list of supplements and/or passport. Trusted athlete application 30 may request all of the information described above from the agency or governing body and display the information received to user 10. Trusted athlete application 30 may also transmit the information to user 10 and/or to one or more monitoring users 60, including coaches, parents, and/or sponsors. Trusted athlete application 30 may display the information to user 10 and also be downloaded from the application to be stored in another form.

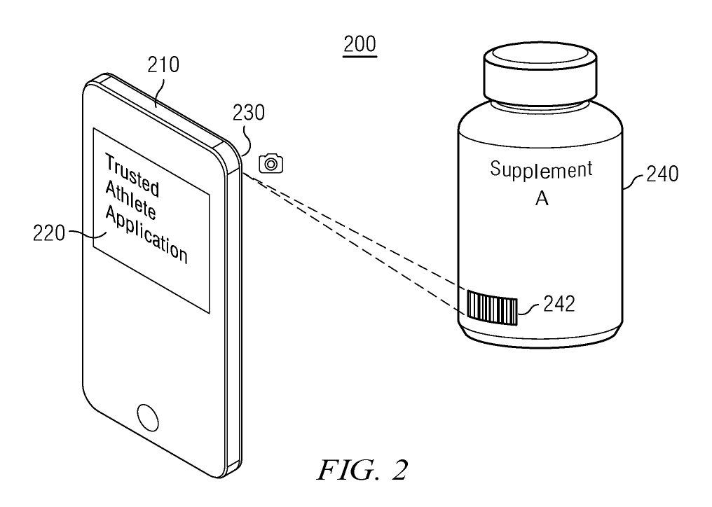

With reference to FIG. 2, a real-world implementation of a system 200 for providing information regarding the legality of products to users in real time is illustrated in accordance with a non-limiting embodiment of the present disclosure. System 200 may include, for example, mobile device 210. Mobile device 210 may include a built-in camera 230 and trusted athlete application 220. Trusted athlete application 220 may use camera 230 to scan barcode 242 of product 240. Product 240 may be, for example, a bottle of Supplement A. User 10 may be interested in using Supplement A to help rebuild muscles after a workout. Trusted athlete application 220 may determine in real time that Supplement A is illegal in the United States and alert user 10 as to its illegality.

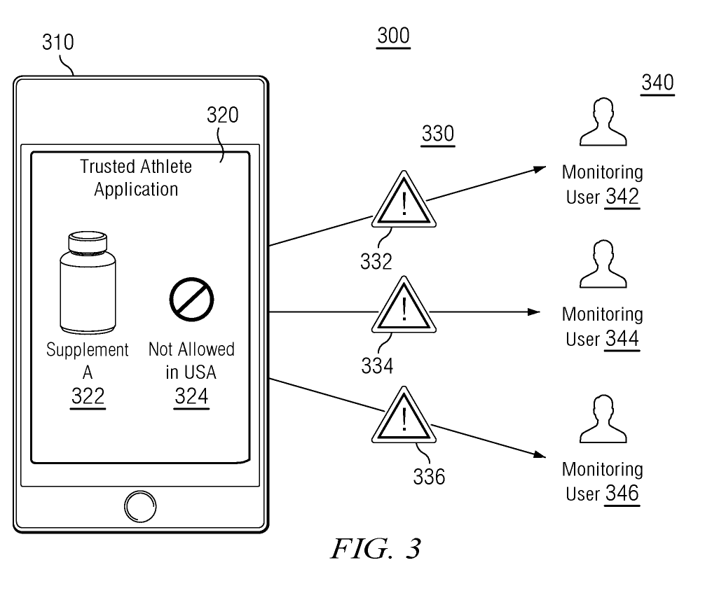

With reference to FIG. 3, a real-world implementation of a system 300 for providing information regarding the legality of products to users in real time is illustrated in accordance with a non-limiting embodiment of the present disclosure. System 300 may include mobile device 310. User 10 uses trusted athlete application 320 on mobile device 310, which scans the barcode for Supplement A and determines that Supplement A is not allowed in the United States. Trusted athlete application 320 displays both an icon 322 illustrating Supplement A and an icon 324 illustrating, for example with a slashed circle, that Supplement A is not legal in the United States. In response to determining that Supplement A is not legal in the United States, trusted athlete application 320 sends alerts 330, for example alert 332, alert 334, and alert 336, in real time to monitoring users 340, including monitoring user 342, monitoring user 344, and monitoring user 344.

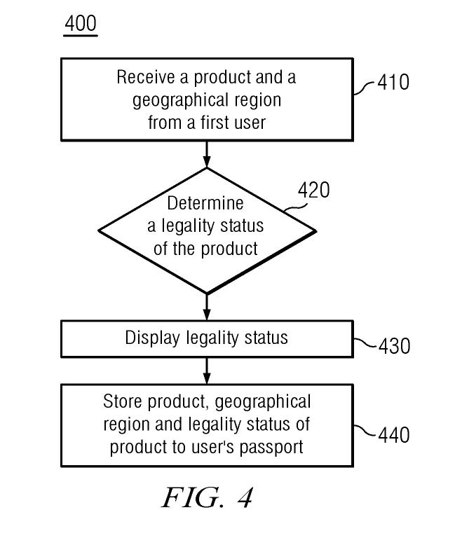

With reference to FIG. 4, a flow chart of a method 400 for providing information regarding the legality of products to users in real time is illustrated in accordance with a non-limiting embodiment of the present disclosure. At step 410, method 400 receives a product and a geographical region from a first user. At step 420, method 400 determines a legality status of the product. At step 430, method 400 displays the legality status. At step 440, method 400 stores the product, the geographical region, and the legality status of the product to the user's passport.

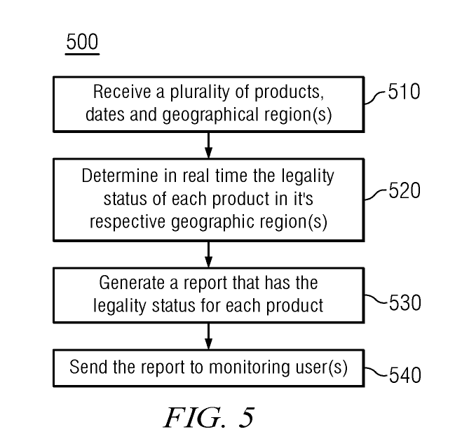

With reference to FIG. 5, a flow chart of a method 500 for providing information regarding the legality of products to users in real time is illustrated in accordance with a non-limiting embodiment of the present disclosure. At step 510, method 500 receives a plurality of products, dates, and geographical regions. At step 520, method 500 determines in real time the legality status of each product in its respective geographical region(s). At step 530, method 500 generates a report that has the legality status for each product. At step 540, method 500 sends the report to one or more monitoring users.

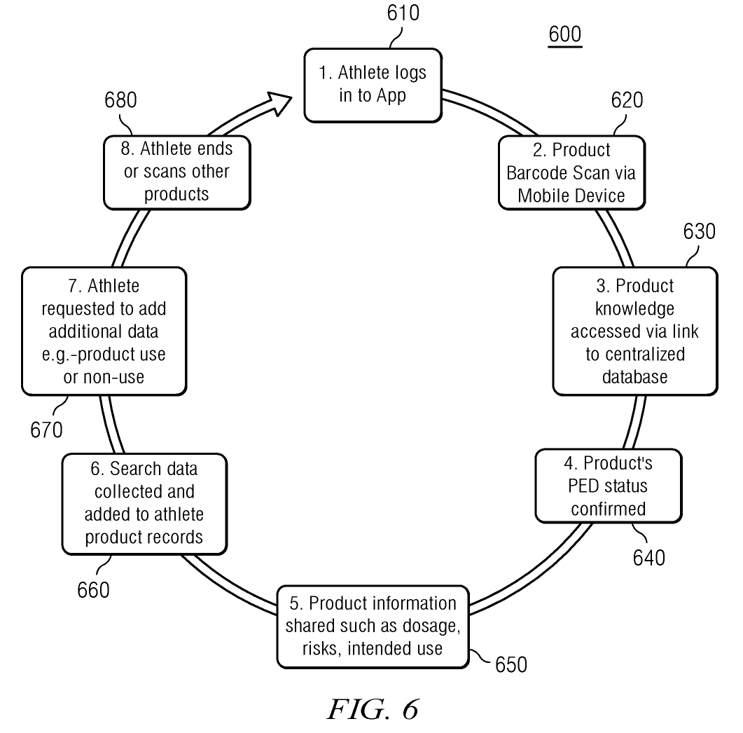

With reference to FIG. 6, a flow chart of a method 600 for providing information regarding the legality of products to users in real time is illustrated in accordance with a non-limiting embodiment of the present disclosure. At step 610, an athlete logs into the trusted athlete application. At step 620, trusted athlete application 30 scans a product barcode via the built-in camera of a mobile device. At step 630, user 10 accesses knowledge about the scanned product via a link to a centralized database 40. At step 640, trust athlete application 30 confirms the product's performance-enhancing drug (PED) status. At step 650, trust athlete application 30 shares product information, including for example dosage, risks, and intended use of the scanned product. At step 660, trust athlete application 30 searches through data that has been collected and added to user 10's athlete records and records associated with the scanned product. At step 670, trusted athlete application 30 requests that user 10 add additional data, for example data regarding user 10's use or non-use of the product. At step 680, user 10 ends its use of trusted athlete application 30 or trusted athlete application 30 scans additional products.

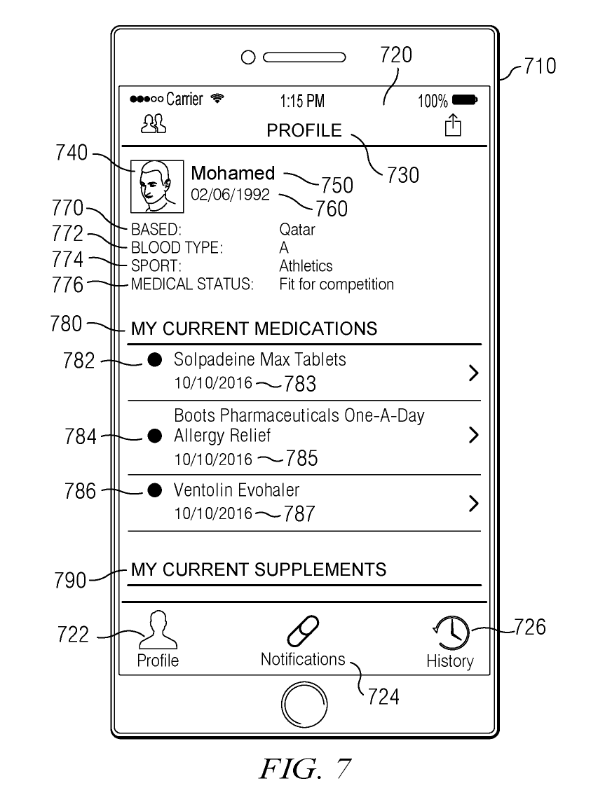

With reference to FIG. 7, a real-world implementation of a system for providing information regarding the legality of products to users in real time is illustrated in accordance with a non-limiting embodiment of the present disclosure. Trusted athlete application 720 runs on mobile device 710. Trusted athlete application 720 may store in memory 22 and display user 10's photograph 740 and identifying information. Identifying information may include user 10's name 750, user 10's birthdate 760, and other identifying information including, for example, home geographical location 770, blood type 772, associated sport(s) 774, and medical status 774. Trusted athlete application 720 may also store in memory 22 and display one or more current medications 780. Current medications 780 may include one or more medications that user 10 is currently taking. Trusted athlete application 720 may display the product name 782 and associated date(s) 783, the product name 784 and associated date(s) 785, and the product name 786 and associated date(s) 787. Trusted athlete application 720 may also display current supplements 790 separately with current medications, or in the same display. Trusted athlete application 720 may also display a profile icon 722, medications icon 724, and history icon 726.

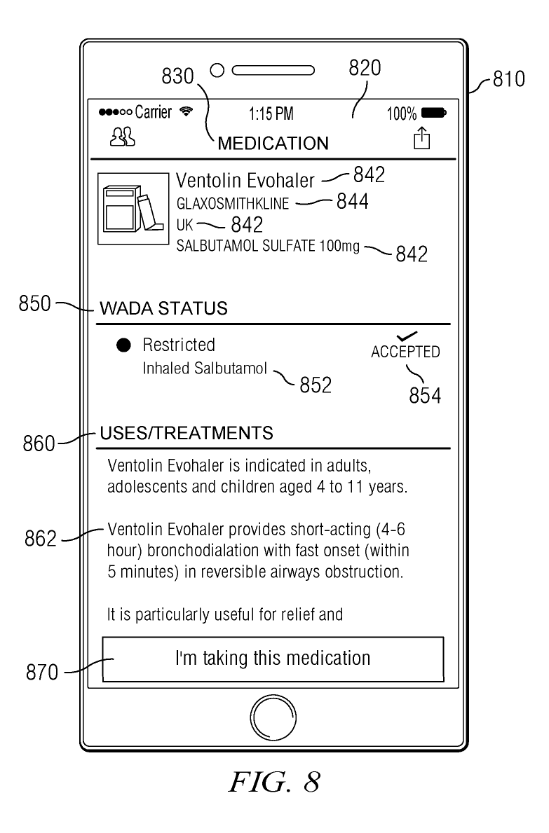

With reference to FIG. 8, a real-world implementation of a system for providing information regarding the legality of products to users in real time is illustrated in accordance with a non-limiting embodiment of the present disclosure. Trusted athlete application 820 runs on mobile device 810. Trusted athlete application 820 may include medication profile 830, which may contain one or more medications. Trusted athlete application 820 may include a photograph 840 of a medication, a medication name 842, pharmaceutical company 844 that makes or distributes the medication, country 846 where the medication is made, and chemical name 848 at the medication is known by. Trusted athlete application 820 may contain and display a WADA status 850, for example that the medication is “restricted” 852. Trusted athlete application 820 may display that the accepted status 854, which may display as unaccepted or pending acceptance. Trusted athlete application 820 may contain and display uses and/or treatments 860 of the medication. Trusted athlete application 820 may display one or more words and/or paragraphs of information 862 describing the medication, including its uses and treatment options. Trusted athlete application 820 may have a button or icon 870 allowing user 10 to select that he or she is currently and/or has historically taken the medication. Once user 10 selects this button, trusted athlete application 820 may add the medication to user 10's passport and store the medication in memory 22. Trusted athlete application 820 may retrieve the prose describing the use(s) and treatments for the medication from database 40 and/or over network 50.

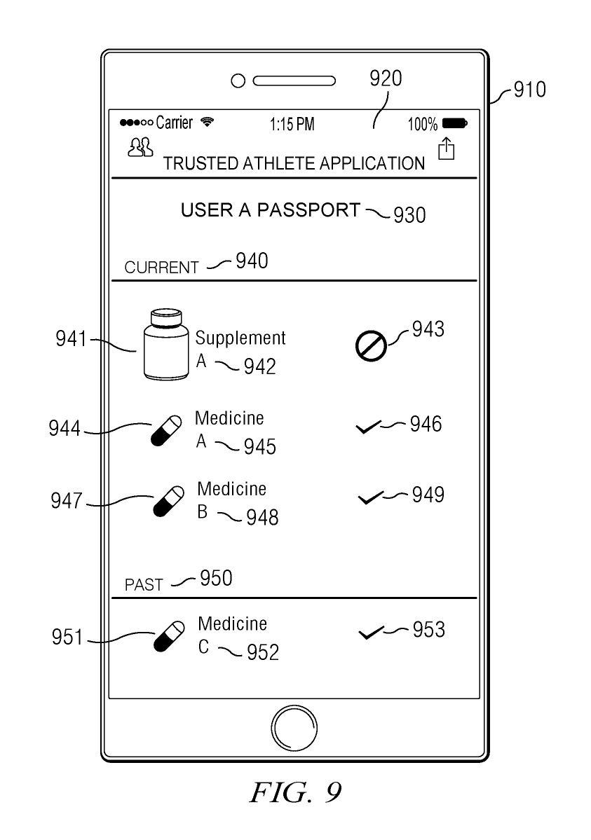

With reference to FIG. 9, a real-world implementation of a system for providing information regarding the legality of products to users in real time is illustrated in accordance with a non-limiting embodiment of the present disclosure. Trusted athlete application 920 runs on mobile device 910. Trusted athlete application 920 may include passport 930 for user 10. Passport 930 may include current products 940 and/or past or historical products 950. Current products 940 may list one or more products that user 10 is currently taking, for example Supplement A. Trusted athlete application 920 may display a photograph or other illustration 941 of Supplement A, a name 942 for Supplement A, and a legality status 943 of Supplement A in the geographical region indicated by user 10. Trusted athlete application 920 may display a photograph or other illustration 944 of Medicine A, a name 945 for Medicine A, and a legality status 946 of Medicine A in the geographical region indicated by user 10. Trusted athlete application 920 may display a photograph or other illustration 947 of Medicine B, a name 948 for Medicine B, and a legality status 949 of Medicine B in the geographical region indicated by user 10. Past products 950 may list one or more products that user 10 has historically taken but no longer takes, for example Medicine C. Trusted athlete application 920 may display a photograph or other illustration 951 of Medicine C, a name 952 for Medicine C, and a legality status 953 of Medicine C in the geographical region indicated by user 10.

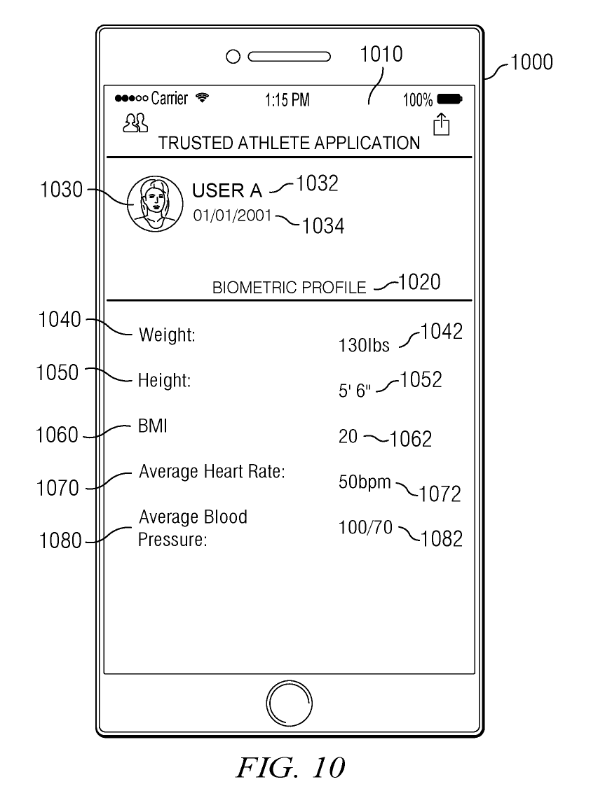

With reference to FIG. 10, a real-world implementation of a system for providing information regarding the legality of products to users in real time is illustrated in accordance with a non-limiting embodiment of the present disclosure. Trusted athlete application 1010 runs on mobile device 1000. Trusted athlete application 1010 may include biometric profile 1020 for user 10. Trusted athlete application 1010 may display a photograph or illustration 1030 of user 10, a name 1032 of user 10, and a birthdate 1034 of user 10. Biometric profile 1020 may include biometrics of user 10, including key marker names and the corresponding biometric for user 10, for example weight 1040 and user 10's weight 1042, height 1050 and user 10's height 1052, body mass index (BMI) 1060 and user 10's BMI 1062, average heart rate 1070 and user 10's average heart rate 1072, and average blood pressure 1080 and the user's average blood pressure 1082.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of computer readable media having computer readable program code embodied thereon.

Any combination of one or more computer readable media may be utilized. The computer readable media may be a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving, from a first user, indications of:
a first product; and
a first geographical region;
determining in real time, using a processor, a legality status of the first product, the legality status indicating whether the first product is legal in the first geographical region;
displaying the legality status of the first product; and
storing the first product, the first geographical region, and the legality status of the first product to a passport for the first user.

2. The method of claim 1, further comprising:
retrieving customs documentation for the first geographical region; and
transmitting the customs documentation to the first user.

3. The method of claim 1, wherein the indication of the first product comprises a scanned barcode, the barcode uniquely identifying the first product.

4. The method of claim 1, wherein the legality status is negative, and wherein the method further comprises sending an alert in real time to a monitoring user, the monitoring user being different from the first user.

5. The method of claim 1, further comprising:
receiving, from the first user, indications of:
a plurality of products;
for each product of the plurality of products:
a plurality of dates of use of the product; and
a geographic region in which the product is used;
determining in real time a legality status of each product of the plurality of products, the legality status indicating whether the product is legal in the geographical region;
generating a report comprising the legality status of each product of the plurality of products; and
sending the report to a monitoring user, the monitoring user being different from the first user.

6. The method of claim 5, wherein the plurality of products comprises products that the first user has indicated an intent to use.

7. The method of claim 5, wherein the plurality of products comprises products that the first user has used historically.

8. The method of claim 1, further comprising:
creating a profile for the first user, the profile comprising a plurality of information associated with the first user; and
creating the passport for the first user.

9. The method of claim 8, further comprising:
generating a biometric portion of the profile for the first user;
receiving an indication of a health marker for the first user;
determining whether the health marker is associated with the first product; and
displaying an indication of whether the health marker is associated with the first product.

10. The method of claim 1, wherein the first product is selected from the group consisting of:
a medicine;
an herb;
a supplement; and
a drug.

11. A system comprising:
a processor; and
a memory coupled to the processor comprising instructions executable by the processor, the processor being operable when executing the instructions to:
create a passport for the first user;
receive, from a first user, indications of:
a first product; and
a first geographical region;
determine in real time, using the processor, a legality status of the first product, the legality status indicating whether the first product is legal in the first geographical region;
display the legality status of the first product; and
store the first product, the first geographical region, and the legality status of the first product to a passport for the first user.

12. The system of claim 11, the processor being further operable when executing the instructions to:
retrieve customs documentation for the first geographical region; and
transmit the customs documentation to the first user.

13. The system of claim 11, wherein the indication of the first product comprises a scanned barcode, the barcode uniquely identifying the first product.

14. The system of claim 11, wherein the legality status is negative, and wherein the processor is further operable when executing the instructions to sending an alert in real time to a monitoring user, the monitoring user being different from the first user.

15. The system of claim 11, the processor being further operable when executing the instructions to:
receive, from the first user, indications of:
a plurality of products;
for each product of the plurality of products:
a plurality of dates of use of the product; and
a geographic region in which the product is used;
determine in real time a legality status of each product of the plurality of products, the legality status indicating whether the product is legal in the geographical region;
generate a report comprising the legality status of each product of the plurality of products; and
send the report to a monitoring user, the monitoring user being different from the first user.

16. The system of claim 15, wherein the plurality of products comprises products that the first user has indicated an intent to use.

17. The system of claim 15, wherein the plurality of products comprises products that the first user has used historically.

18. The system of claim 11, the processor being further operable when executing the instructions to:
create a profile for the first user, the profile comprising a plurality of information associated with the first user; and
create the passport for the first user.

19. The system of claim 18, the processor being further operable when executing the instructions to:
generate a biometric portion of the profile for the first user;
receive an indication of a health marker for the first user;
determine whether the health marker is associated with the first product; and
display an indication of whether the health marker is associated with the first product.

20. One or more computer-readable non-transitory storage media in one or more computing systems, the media embodying logic that is operable when executed to:
create a passport for the first user;
receive, from a first user, indications of:
a first product; and
a first geographical region;
determine in real time, using the processor, a legality status of the first product, the legality status indicating whether the first product is legal in the first geographical region;
display the legality status of the first product; and
store the first product, the first geographical region, and the legality status of the first product to a passport for the first user.
